(19) United States
(12) Patent Application Publication
(10) Pub. No.: US 2024/0294170 A1
(43) Pub. Date: Sep. 5, 2024

(54) TRANSIT VEHICLE HAVING MULTIPLE OPERATIONAL MODES

(71) Applicant: Sam Schwartz, New York, NY (US)

(72) Inventor: Sam Schwartz, New York, NY (US)

(21) Appl. No.: 18/591,634

(22) Filed: Feb. 29, 2024

Related U.S. Application Data
(60) Provisional application No. 63/449,199, filed on Mar. 1, 2023.

(51) Int. Cl. B60W 30/182; B60W 60/00

(52) U.S. Cl. CPC B60W 30/182; B60W 60/005; B60W 2300/10; B60W 2420/403; B60W 2420/408; B60W 2556/50

(57) ABSTRACT

A transit vehicle and method of operating a transit vehicle include switching an operation of the transit vehicle between a first mode of operation in which the transit vehicle is guided along a fixed pathway by a guide source and a second mode operation in which the transit vehicle is steered by an operator of the transit vehicle. The transit vehicle and method can also switch to a third mode of operation in which the transit vehicle operates autonomously.

### CROSS-REFERENCE TO RELATED APPLICATIONS

This application claims the priority benefit of U.S. Provisional Application No. 63/449,199, filed Mar. 1, 2023, which is hereby incorporated by reference herein in its entirety.

### FIELD OF THE DISCLOSURE

The present disclosure generally relates to transit vehicles.

### BACKGROUND

Transit is generally broken down into two categories: fixed guideway vehicles and on-road vehicles. Some examples of fixed guideway vehicles include trains, light rail transit (LRT) that operates on an exclusive right-of-way (ROW), or trams/buses having tires that move within fixed routes. In addition to physical guideways, some systems utilize optical guidance that follow marked guideways or global navigation satellite systems (GNSS) for guided movement. On-road vehicles include buses, which can be articulated similar to an LRT system for high-capacity systems.

### SUMMARY

In accordance with a first aspect, a transit vehicle is described herein that includes a control system configured to switch an operation of the transit vehicle between a first mode of operation in which the transit vehicle is guided along a fixed pathway by a guide source and a second mode operation in which the transit vehicle is steered by an operator of the transit vehicle.

In some examples, the guide source can be a global navigation satellite system and/or an optical guidance system.

In some examples, the transit vehicle includes a control panel including a lever for control of the transit vehicle in the first mode of operation and a steering wheel for control of the transit vehicle in the second mode of operation. The transit vehicle can include an operational switch configured to switch the transit vehicle from the first mode of operation to the second mode of operation. For example, the operational switch can be a sensor that is configured to determine when an operator touches and/or turns the steering wheel. The transit vehicle can include a second operational switch configured to switch the transit vehicle from the second mode of operation to the first mode of operation.

In some examples, the control system is further configured to switch the operation of the transit vehicle the first mode of operation, the second mode of operation, and a third mode of operation in which the transit vehicle operates autonomously. The transit vehicle can include LIDAR, radar, and/or machine vision that is configured to operate with the transit vehicle in the third mode of operation.

In any of the above examples, the transit vehicle can include a body having front and rear wheels. In further examples, the body includes intermediate wheels and one or more articulation joints between body portions. The body can have a width of about 9 feet to about 10 feet.

In accordance with a second aspect, a method of operating a transit vehicle is described that includes operating the transit vehicle in a first mode of operation in which the transit vehicle is guided along a fixed pathway by a guide source and operating the transit vehicle in a second mode operation in which the transit vehicle is steered by an operator of the transit vehicle

In some examples, operating the transit vehicle in the first mode of operation includes guiding the transit vehicle along the fixed pathway with a global navigation satellite system and/or an optical guidance system.

In some examples, operating the transit vehicle in the first mode of operation includes controlling movement of the transit vehicle along the fixed pathway via movement of a lever and operating the transit vehicle in the second mode of operation includes controlling movement of the transit vehicle with a steering wheel. In further examples, the method includes switching between the first mode of operation and the second mode of operation with one or more operational switches, such as touching or turning the steering wheel.

In some examples, the method includes operating the transit vehicle in a third mode of operation in which the transit vehicle is operated autonomously.

### BRIEF DESCRIPTION OF THE DRAWINGS

FIG. 1 is a diagrammatic view of a vehicle and example guide sources in accordance with the teachings of the present disclosure;

FIG. 2 is an example control panel for the vehicle of FIG. 1;

FIG. 3 is a diagrammatic view of a control system configuration for a vehicle in accordance with the teachings of the present disclosure; and

FIG. 4 is a diagram of vehicle turning paths.

### DETAILED DESCRIPTION

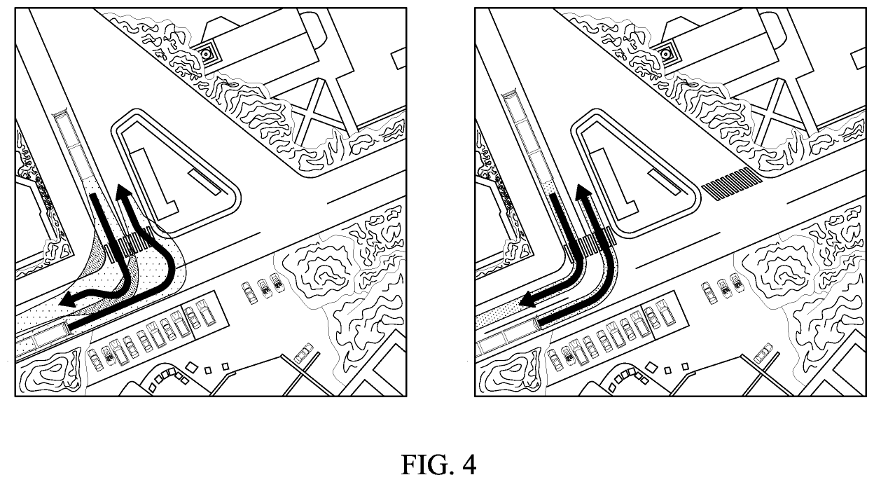

Buses have the advantage of being able to maneuver around obstacles and be easily rerouted as passenger travel patterns change. Buses require no special infrastructure, reducing start up or revision costs, and could operate on any street wide enough for the vehicle. However, in an on-street environment, buses need wide lanes to account for driver sway and different driver patterns. Furthermore, when turning, buses need a wide swath or turn pattern to account for the fact that the rear wheels don't follow the same path as the front wheels as shown on the left side of FIG. 4.

Trains have the advantage of being able to follow a precise path and thus require relatively narrower lane widths than buses. Moreover, the rear wheels of the train, and any intermediary wheels, follow the same path as the front wheels, allowing trains to have tighter turns than buses. The drawbacks of trains, however, include building a track or other routed guideway bed, and installing and maintaining rails or other guideway infrastructure. Further, trains are stopped until obstacles can be removed and changing routes is a lengthy and costly process.

The systems and methods described herein provide a transit vehicle that takes advantage of the best of bus rapid transit and light rail transport without the aforementioned drawbacks. For example, the transit vehicle can follow precise paths similar to a rail-based system as shown on the right side of FIG. 4 without the associated costs, as well as allow an operator to drive around obstacles or easily reroute.

The systems, vehicles, and methods described herein have multiple operational mode to provide the benefits associated with both fixed guideway vehicles and on-road vehicles. The systems and methods default to operation according to a fixed guideway to ensure that the vehicle follows a precise, predetermined path. Further, the vehicle allows an operator to switch from the fixed guideway mode of operation to an on-road vehicle mode of operation to allow the operator to maneuver the vehicle around any obstacles or according to any other reason that may require the vehicle to leave the fixed guideway path. Thereafter, the operator may reenter the fixed guideway mode of operation. In some examples, reentering the fixed guideway may include the operator driving the vehicle back onto the fixed guideway before switching the mode of operation via a user input or by switching the mode of operation upon which the vehicle is guided back to the fixed guideway.

The systems, vehicles, and methods described herein can further take advantage of the features of autonomous vehicles in a third mode of operation. For example, the vehicle can operate autonomously to return to the guided pathway and/or operate autonomously after completion of a shift or route to return to a maintenance/charging/storage facility. The autonomous mode of operation allows for more efficient re-charging or refueling of the vehicles, as well as a smaller storage footprint.

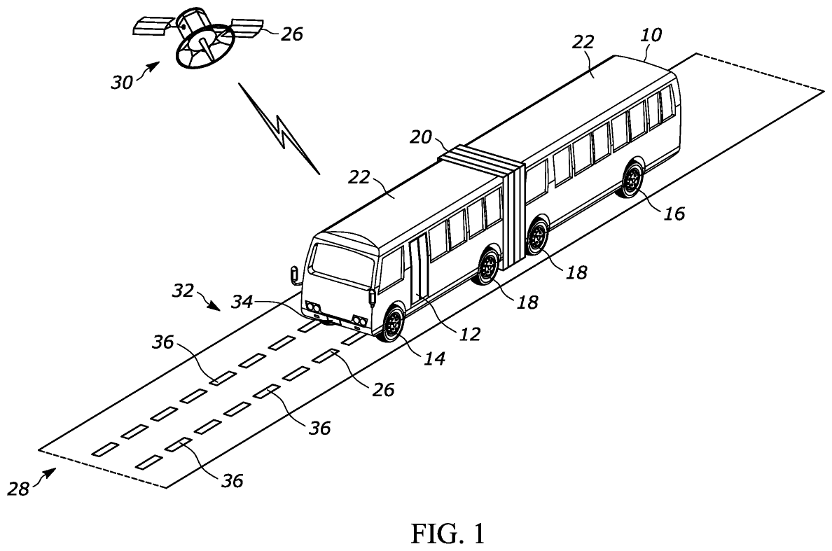

Referring now to FIGS. 1-3, a transit vehicle 10 according to the present disclosure may include a body 12 having front and rear wheels 14, 16. In some examples, the vehicle 10 may include one or more intermediate wheels 18, such as with articulated vehicles. The vehicle 10 can have any suitable length. In some examples, the vehicle body 12 may include one or more articulation joints 20 disposed between rigid sections 22. Vehicles with articulation joints may include a steering arrangement where the axles of the wheels 14, 16, 18 are turned to negotiate tighter turns than a rigid arrangement. The steering arrangement can utilize wheel precision whereby the front axle communicates its path to all successive axles to follow the same path to ensure that the rear wheels 16 and any intermediate wheels 18 follow the exact path of the front wheels 14, such that the vehicle 10 can be operated in very tight rights-of-way and negotiate narrow, sharp turns. Example steering arrangements can be found in some bus-trolley systems. The vehicle 10 may also include one or more doors 24 (e.g., front, intermediate, and/or rear doors) allowing passengers to enter and exit the vehicle 10.

The vehicle 10 may be electric and/or gas fueled for operation. The vehicle 10 may further include automatic braking systems (ABS) 25 operational at least while operating in the autonomous mode of operation. In some examples, the body 12 can have a width of about 9 feet, such that the vehicle 10 can be configured to operate within a 10 foot right-of-way in the first mode of operation. In other examples, the body 12 can have a width of between about 9 feet and 10 feet.

The vehicles 10 described herein are on-road vehicles that do not require physical tracks or other structures that the vehicle 10 engages during travel. Instead, a guide source 26 can be utilized to guide the vehicle 10 along a fixed guideway or path 28. In one example, the guide source 26 can be any suitable global navigation satellite system (GNSS) 30 in communication with a suitable receiver 31. In some implementations, the GNSS 30 may ensure that the vehicle 10 is guided along the fixed guideway 28 within one to two inches laterally. In another example, the guide source 26 may be an optical system 32 that includes one or more cameras 34 or equivalent structure and corresponding image processing to read pavement markings 36 to follow a precise path. For example, the cameras 34 and image processing may compare a trajectory of the vehicle 10 to the markings 36 a predetermined distance ahead of the vehicle 10, e.g., 50 feet, 100 feet, etc. The fixed guideway 28 is a predetermined path. In some examples, such as with the GNSS 30, the system can be programmed to adapt or change the path temporarily or permanently. The vehicle 10 can be operable on more than one path according to programming or by placing the vehicle on the desired fixed guideway 28.

In some examples, the vehicle 10 can include LIDAR (light detection and ranging) 38, radar 39, and/or machine vision 41 (e.g., automated information extraction from an image or images). The LIDAR 38, radar 39, machine vision 41, and/or optical system 32 can be used to detect pedestrians, other traffic, obstacles, and so forth during operation of the vehicle 10, such as while within the autonomous mode of operation and in conjunction with operation of the ABS 25. These features allow the vehicle 10 to operate along routes in dense urban areas.

The guide source(s) 26, along with the LIDAR 38/radar 39/machine vision 41 if included, are operable to guide movement of the vehicle 10 into and out of transit stations with spacing in compliance with Americans with Disability Access (ADA) requirements (e.g., within an inch of the platform). While at platforms at the transit stations, the operator will open/close the door(s) 24 and monitor passenger boarding and alighting.

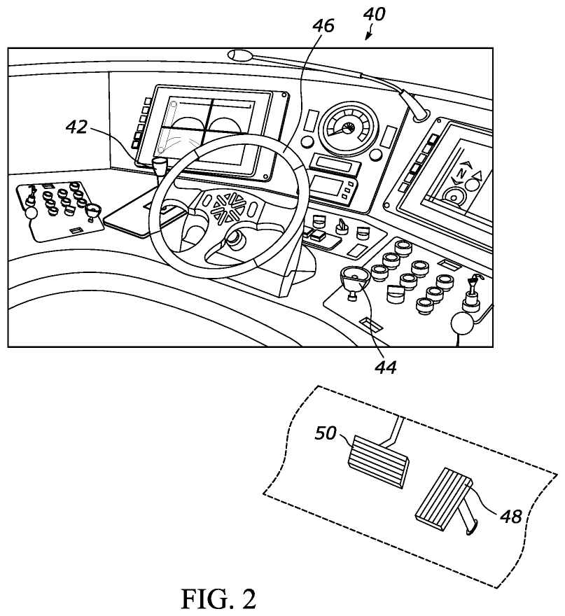

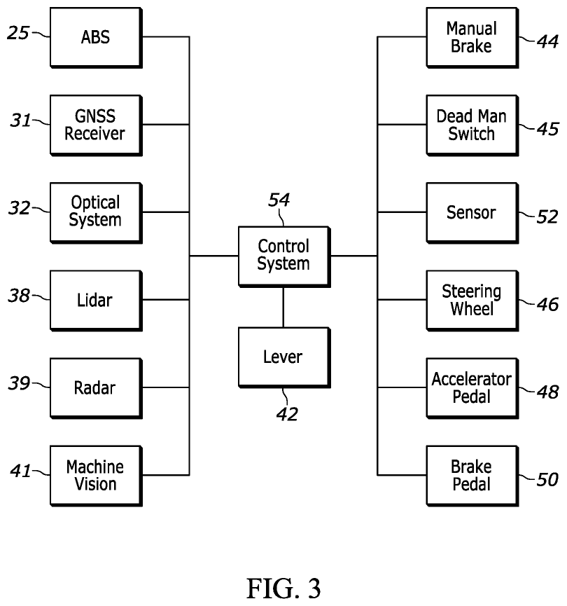

An example control panel 40 for the vehicle 10 is shown in FIG. 2 and a diagrammatic configuration for a control system 54 of the vehicle 10 is shown in FIG. 3. The control panel 40 includes a lever 42 similar to a train control that is operational to initiate movement, accelerate the vehicle 10, and for speed control. Releasing pressure on the lever 42 may provide braking for the vehicle 10 and/or the control panel 40 can include a separate, manual brake 44. In some examples, the vehicle 10 can include a “dead man” switch 45, such as on the control panel 40, operator chair, etc., that automatically brakes the vehicle 10 in the event the operator is incapacitated. The control panel 40 can also include other gauges or system indicators (e.g., temperature, speed, fuel, etc.).

The control panel 40 also includes controls for conventional on-road operation. For example, the control panel 40 includes a steering wheel 46 that controls steering of the vehicle 10 as a conventional steering wheel, an accelerator pedal 48, and a brake pedal 50. The vehicle 10 can also include suitable indicators, such as hazard lights, turn signal lights, and so forth.

An operator would be present in a front compartment of the vehicle 10. In the fixed guideway mode of operation, the operator drives the vehicle 10 as they would a train by moving the lever 42 and, optionally, the manual brake 44 to move forward, accelerate, decelerate, and brake. The operator can open and close the door(s) 24 using any suitable mechanism (e.g., levers, hydraulic mechanism, etc.) at transit stations or other passenger locations.

In the event there is an obstacle in the road or other need to reroute the vehicle 10, the operator may take full control of the vehicle 10 pursuant to an operational switch to the on-road vehicle mode of operation. The operational switch may be any suitable mechanism. For example, the operational switch may be performed by grabbing (e.g., touching and/or moving) the steering wheel 46. This determination can be made by a suitable sensor 52, such as an induction sensor, that can determine when the operator grabs the steering wheel 46. Alternatively, the operational switch may be controlled according to a controller of the vehicle 10 determining that the operator is turning the steering wheel 46. Determining that the steering wheel 46 is being moved by can be done using any suitable sensor 52, e.g., electrical or mechanical sensor, configured to detect rotation of the steering wheel 46, movement of one or more of the wheels 14, 16, 18, or movement of connecting structure therebetween. Thereafter, the operator would be able to freely turn the steering wheel 46 and operate the vehicle 10 as a bus or similar vehicle, using the accelerator pedal 48 and the brake pedal 50 for example. In some examples, the operational switch can be similar to that being used during cruise control or automatic pilot in some cars. The operational switch can correspond to the operator moving the accelerator pedal 48, the brake pedal 50, and/or the brake 44. In another example, the operational switch can correspond to the operator releasing the lever 42, such that the vehicle 10 would automatically switch to manual control. In yet another example, the operational switch may be a dedicated switch (e.g., push button, toggle, etc.) that can be actuated to switch the vehicle 10 between the modes of operation.

After the operator determines that the vehicle 10 can safely return to guided operation, the vehicle 10 can be returned to the fixed guideway 28 and the fixed guideway mode of operation. Returning to the fixed guideway 28 and the fixed guideway mode of operation can be achieved by any suitable method. For example, the operator may manually steer the vehicle 10 back to the fixed guideway 28 and then switch to the fixed guideway mode of operation via an operational switch. Alternatively, the operator may switch to the fixed guideway mode of operation via the operational switch and the guide source 26 or autonomous operation in the third mode can guide the vehicle 10 back to the fixed guideway 28. The operational switch can be the same operational switch used to switch to the on-road vehicle mode of operation. Alternatively, the operational switch can correspond to the operator touching or moving the lever 42.

The methods and systems herein may include a corresponding control system 54 coupled to and configured to control the operation of the components of the vehicle 10 described herein. The control system may refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control system may be configured (for example, by using corresponding programming stored in a memory as will be well understood by those skilled in the art) to carry out one or more of the steps, actions, and/or functions described herein.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A transit vehicle comprising a control system configured to switch an operation of the transit vehicle between a first mode of operation in which the transit vehicle is guided along a fixed pathway by a guide source and a second mode operation in which the transit vehicle is steered by an operator of the transit vehicle.

2. The transit vehicle of claim 1, wherein the guide source comprises a global navigation satellite system.

3. The transit vehicle of claim 1, wherein the guide source comprises an optical guidance system.

4. The transit vehicle of claim 1, further comprising a control panel including a lever for control of the transit vehicle in the first mode of operation and a steering wheel for control of the transit vehicle in the second mode of operation.

5. The transit vehicle of claim 4, further comprising an operational switch configured to switch the transit vehicle from the first mode of operation to the second mode of operation.

6. The transit vehicle of claim 5, wherein the operational switch comprises a sensor configured to determine when an operator touches the steering wheel.

7. The transit vehicle of claim 5, wherein the operational switch comprises a sensor configured to determine when an operator turns the steering wheel.

8. The transit vehicle of claim 4, further comprising a second operational switch configured to switch the transit vehicle from the second mode of operation to the first mode of operation.

9. The transit vehicle of claim 1, wherein the control system is further configured to switch the operation of the transit vehicle the first mode of operation, the second mode of operation, and a third mode of operation in which the transit vehicle operates autonomously.

10. The transit vehicle of claim 9, further comprising at least one of LIDAR, radar, or machine vision configured to operate with the transit vehicle in the third mode of operation.

11. The transit vehicle of claim 1, further comprising a body having front and rear wheels.

12. The transit vehicle of claim 11, wherein the body further comprises intermediate wheels and one or more articulation joints between body portions.

13. The transit vehicle of claim 11, wherein the body has a width of about 9 feet to about 10 feet.

14. A method of operating a transit vehicle, the method comprising:
operating the transit vehicle in a first mode of operation in which the transit vehicle is guided along a fixed pathway by a guide source; and
operating the transit vehicle in a second mode operation in which the transit vehicle is steered by an operator of the transit vehicle

15. The method of claim 14, wherein operating the transit vehicle in the first mode of operation comprises guiding the transit vehicle along the fixed pathway with a global navigation satellite system.

16. The method of claim 14, wherein operating the transit vehicle in the first mode of operation comprises guiding the transit vehicle along the fixed pathway with an optical guidance system.

17. The method of claim 14, wherein operating the transit vehicle in the first mode of operation comprises controlling movement of the transit vehicle along the fixed pathway via movement of a lever; and operating the transit vehicle in the second mode of operation comprises controlling movement of the transit vehicle with a steering wheel.

18. The method of claim 17, further comprising switching between the first mode of operation and the second mode of operation with one or more operational switches.

19. The method of claim 18, wherein switching from the first mode of operation to the second mode of operation comprises touching or turning the steering wheel.

20. The method of claim 14, further comprising operating the transit vehicle in a third mode of operation in which the transit vehicle is operated autonomously.
